(19) United States
(12) Patent Application Publication
(10) Pub. No.: US 2010/0173216 A1
(43) Pub. Date: Jul. 8, 2010

(54) OPTIMIZING PERFORMANCE OF END CELLS IN A FUEL CELL STACK

(76) Inventors: Hao Tang, Montreal (CA); Dingrong Bai, Dorval (CA); David Elkaïm, Ville Saint-Laurent (CA); Jean-Guy Chouinard, Ville Saint-Laurent (CA)

Correspondence Address: OGILVY RENAULT LLP, 1, Place Ville Marie, SUITE 2500, MONTREAL, QC, H3B 1R1, CA

(21) Appl. No.: 12/377,172

(22) PCT Filed: Aug. 16, 2007
(86) PCT No.: PCT/CA07/01432

§ 371 Date: Feb. 11, 2009

Related U.S. Application Data
(60) Provisional application No. 60/837,929, filed on Aug. 16, 2006.

(51) Int. Cl. H01M 8/24

(52) U.S. Cl. 429/452

(57) ABSTRACT

There are described various techniques used to optimize end cell performance of a fuel cell stack, such as varying the thickness of a membrane throughout the stack, varying the material of the membrane throughout the stack, varying the size of the active area throughout the stack, and varying the catalyst loading throughout the stack.

### CROSS-REFERENCE TO RELATED APPLICATIONS

The present application claims priority of U.S. Provisional Patent Application filed on Aug. 16, 2006 and bearing Ser. No. 60/837,929.

### TECHNICAL FIELD

The present invention relates to the field of fuel cells, and more particularly to the design of a fuel cell stack to improve water management, performance, and lifetime of end cells in the stack.

### BACKGROUND OF THE INVENTION

Generally, fuel cell stack performance and lifetime are determined by its individual cells, i.e., if any individual cell loses its performance or lifetime, the stack will be out of service. Therefore, reducing cell-to-cell voltage variation in a stack and improving individual cell performance and lifetime is one of the fuel cell industry's major research and development activities.

Due to various mechanisms, such as anode/cathode reactants distributions, thermal uniformity, and water management variations, end cell performance is generally lower than the performance of the other cells in the stack, leading to a relatively shorter lifetime compared to the middle cells. As illustrated in FIG. 1, lower cell temperature and/or temperature gradient within top/bottom cells will stimulate liquid water formation in anode/cathode reactants, i.e. water flooding. Usually, anode flooding is more serious compared to cathode flooding due to high anode reactant unitization (˜80%) and high H₂ concentration (˜70%).

Therefore, there is a need to provide other designs for stacks to reduce end cell anode flooding, and to improve end cell performance and lifetime.

### SUMMARY

There are described various techniques used to manage water in end cells of a fuel cell stack, such as varying the thickness of a membrane throughout the stack, varying the material of the membrane throughout the stack, varying the size of the active area throughout the stack, and varying the catalyst loading throughout the stack.

In accordance with a first broad aspect of the present invention, there is provided a fuel cell stack comprising: a plurality of fuel cells each having at least an anode plate, a cathode plate and a membrane electrode assembly (MEA) therebetween, at least one of the plurality of fuel cells having at least one of a membrane and a diffusion layer in the MEA with a first water transportation capability and another one of the plurality of fuel cells having at least one of a membrane and a diffusion layer in the MEA with a second water transportation capability, the first water transportation capability and the second water transportation capability being different.

In accordance with a second broad aspect of the present invention, there is provided a method of operating a fuel cell stack comprising: inputting an anode reactant into an anode inlet and a cathode reactant into a cathode inlet of the fuel cell stack; flowing the anode reactant and the cathode reactant into a plurality of fuel cells in the fuel cell stack on respective flow field plates over a network of flow channels bounded by a series of passages having parallel grooves; chemically reacting the anode reactant and the cathode reactant using catalysts in order to create an electrical current; decreasing a flow of water from a cathode side to an anode side across the membrane electrode assembly of end cells compared to a flow of water of a middle cell; and outputting unused anode reactant and unused cathode reactant through an anode outlet and a cathode outlet, respectively.

In accordance with a third broad aspect of the present invention, there is provided a fuel cell stack comprising: a plurality of fuel cells each having at least an anode plate, a cathode plate and a membrane electrode assembly (MEA) therebetween, at least one of the plurality of fuel cells having a catalyst in the MEA comprising a first catalyst loading and another one of the plurality of fuel cells having a catalyst in the MEA comprising a second catalyst loading, the first catalyst loading and the second catalyst loading being different.

In accordance with a fourth broad aspect of the present invention, there is provided a fuel cell stack comprising: a plurality of fuel cells each having at least a pair of flow field plates and a membrane electrode assembly (MEA) therebetween; at least one of the plurality of fuel cells having a first catalyst covering a first membrane and aligned with a first flow field on at least one of the flow field plates to create a first active area; and another one of the plurality of fuel cells having a second catalyst covering a second membrane and aligned with a second flow field on at least one of the flow field plates to create a second active area, the first active area and the second active area being of different dimensions.

In accordance with a fifth broad aspect of the present invention, there is provided a method of operating a fuel cell stack comprising: inputting an anode reactant into an anode inlet and a cathode reactant into a cathode inlet of the fuel cell stack; flowing the anode reactant and the cathode reactant into a plurality of fuel cells in the fuel cell stack on respective flow field plates over a network of flow channels bounded by a series of passages having parallel grooves; providing a different current density for end cells than a current density for a middle cell; chemically reacting the anode reactant and the cathode reactant over an active area using catalysts in order to create an electrical current; and outputting unused anode reactant and unused cathode reactant through an anode outlet and a cathode outlet, respectively.

### BRIEF DESCRIPTION OF THE DRAWINGS

Further features and advantages of the present invention will become apparent from the following detailed description, taken in combination with the appended drawings, in which:

FIG. 1 illustrates prior art stack designs;

FIG. 2 illustrates a fuel cell stack with thicker membranes used in the end cells than in the middle cell;

FIG. 3 illustrates a fuel cell stack with membranes in the end cells having lower water transportation capability than the membranes in the middle fuel cell;

FIG. 4 illustrates a fuel cell stack with gas diffusion layers having varying degrees of hydrophilicity.

FIG. 5 is a flow chart of an embodiment of a method used to operate a fuel cell stack in which the flow of water is decreased in the end fuel cells;

FIG. 6 illustrates a fuel cell stack with catalyst coatings in the end fuel cells having higher loadings than catalyst coatings in the middle cell; and

FIGS. 7a, 7b, 7c illustrate the active areas of the membrane in a top fuel cell, a middle fuel cell and a bottom fuel cell, respectively.

FIG. 8 is a flow chart of an embodiment of the method used to operate a fuel cell stack in which the current density of the end fuel cells is different from the current density in the middle fuel cell.

It will be noted that throughout the appended drawings, like features are identified by like reference numerals.

### DETAILED DESCRIPTION

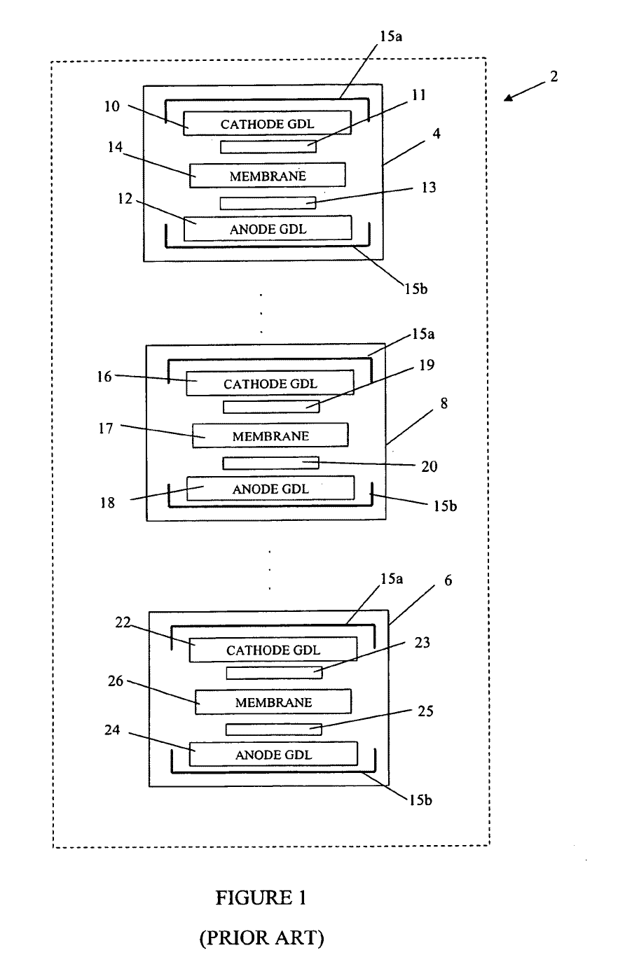

FIG. 1 illustrates a typical fuel cell stack 2 as per the prior art. The fuel cell stack 2 comprises a top fuel cell 4, a bottom fuel cell 6 and at least one fuel cell 8 therebetween. The fuel cells 4, 6 and 8 comprise a cathode plate 15a an anode plate 15b and a membrane electrode assembly (MEA) therebetween, respectively. In the case of the top fuel cell 4, the MEA comprises a cathode gas diffusion layer (GDL) 10, an anode GDL 12, a cathode catalyst layer 11, an anode catalyst layer 13 and a membrane 14 between the cathode catalyst layer 11 and the anode catalyst layer 13. The MEA of the bottom fuel cell 6 comprises a cathode electrode gas diffusion layer (GDL) 22, an anode GDL 24, a cathode catalyst layer 23, an anode catalyst layer 25 and a membrane 26 between the cathode catalyst layer 23 and the anode catalyst layer 25. The structure of the middle cell 8 is substantially the same as that of the two end cells. Typically, the flow field plates 15 are identical in the fuel cells 4, 6, 8 constituting the fuel cell stack 2. All of the cathode and anode GDLs 10, 12, 16, 18, 22, 24 have the same hydrophilicity along the fuel cell stack 2. Furthermore, the membranes 14, 17, 26 have the same thickness and are made of the same material in the fuel cell stack 2. All of the catalyst layers 11, 13, 19, 20, 23, 25 have the same loading and the active area of the membranes 14, 17, 26 are the same through the fuel cell stack. The active area of a membrane is defined as the surface area of the membrane covered by the catalyst layer.

The top fuel cell 4 and the bottom fuel cell 6 are subject to lower temperature and/or temperature gradient than the fuel cell 8 substantially located in the middle of the stack. This lower temperature and/or temperature gradient will stimulate liquid water formation in anode/cathode reactants (i.e. water flooding) in the top 4 and bottom 6 fuel cells. Usually, anode flooding is more serious compared to cathode flooding due to high anode reactant unitization (˜80%) and high H₂ concentration (˜70%).

As described above, the low temperature can lead to accelerated degradation for anode/cathode catalysts, gas diffusion layers and membrane, i.e., the top/bottom cell

Membrane Electrode Assembly (MEA) can have a shorter lifetime compared to its middle cell counterpart.

In one embodiment used to reduce cathode water back diffusion to anode sides, which will eventually reduce or eliminate anode flooding, the water transportation capability of the MEAs varies through the fuel cell stack.

In another embodiment used to reduce cathode water back diffusion to anode sides, the temperature is increased in the end fuel cells.

In one embodiment, the fuel cells located at the top and the bottom of the fuel cell stack have a lower water transportation capability of the MEA than that of the fuel cells located in the middle of the fuel cell stack.

In an embodiment, the MEA of at least one of the fuel cells located at the top of the fuel cell stack has a lower water transportation capability than the remaining of the fuel cells.

In another embodiment, the MEA of at least one of the fuel cells located at the bottom of the fuel cell stack has a lower water transportation capability than the remaining of the fuel cells.

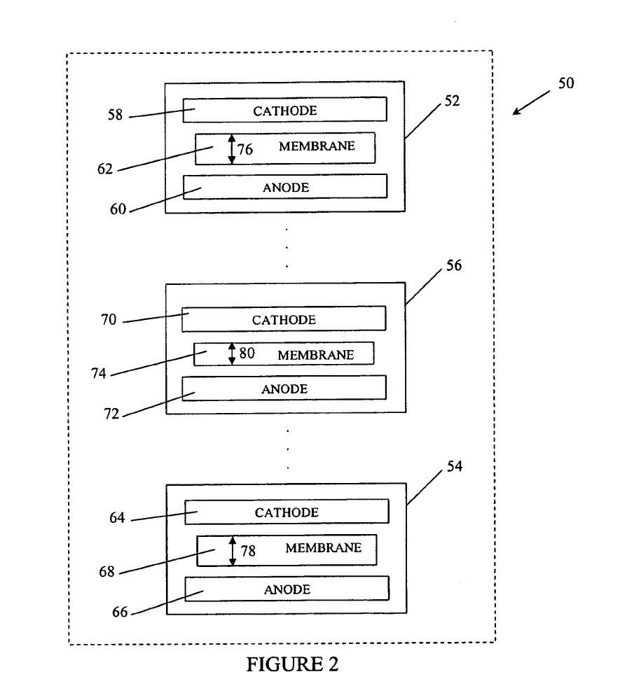

In an embodiment of the present fuel cell stack, the water transportation capability of the MEA is adjusted by varying the thickness of the MEA's membrane. This embodiment is illustrated in FIG. 2. The fuel cell stack 50 comprises a top fuel cell 52, a bottom fuel cell 54 and at least one fuel cell 56 therebetween. In the case of the top fuel cell 52, the MEA comprises a cathode electrode 58, an anode electrode 60 and a membrane 62 of thickness 76 therebetween. The MEA of the bottom fuel cell 54 comprises a cathode electrode 64, an anode electrode 66 and a membrane 68 of thickness 78 therebetween. The MEA of the fuel cell 56 comprises a cathode electrode 70, an anode electrode 72 and a membrane 74 of thickness 80 therebetween. The thickness 76 of the membrane 62 and the thickness 78 of the membrane 68 are superior to the thickness 80 of the membrane 74. As a result, the water back diffusion from the cathode 58, 64 to the anode 60, 66 is reduced in the top and bottom fuel cells 52 and 54 in comparison to the water transfer in the middle fuel cell 56.

In an embodiment, only the end cells have the thicker membrane, while all other cells in the stack have standard size membranes.

In an embodiment, at least one fuel cell located at the top of the fuel cell stack has a thicker membrane than that of the fuel cell located in the middle of the fuel cell stack.

In an embodiment, at least one fuel cell located at the bottom of the fuel cell stack has a thicker membrane than that of the fuel cell located in the middle of the fuel cell stack.

In an embodiment, at least one fuel cell located at the top of the fuel cell stack and at least one fuel cell located at the bottom of the fuel cell stack have a thicker membrane than that of the fuel cell located in the middle of the fuel cell stack.

In an embodiment, the thickness of the membrane gradually or abruptly decreases from at least one of the top fuel cells to the middle fuel cell.

In an embodiment, the thickness of the membrane gradually or abruptly decreases from at least one of the bottom fuel cells to the middle fuel cell.

It should be understood that any combination of membranes having varying thickness throughout the stack may be provided.

Another technique to reduce the cathode water back diffusion to the anode side is to use different types of membranes, such as membranes with lower water solubility and/or lower water diffusion coefficient and/or lower ion exchange capacity for the MEAs located at the top/bottom of the fuel cell stack (i.e. the end cells).

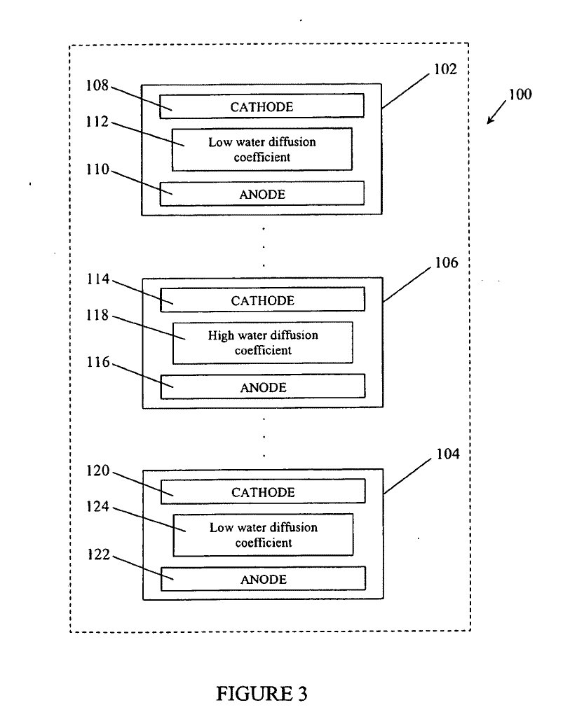

FIG. 3 illustrates an embodiment of the device wherein the membrane of the MEAs located in the two end fuel cells have different water diffusion coefficients than the membrane of the middle cell's MEA. A fuel cell stack 100 comprises a top fuel cell 102, a bottom fuel cell 104 and at least one fuel cell 106 therebetween. The top fuel cell 102, the bottom fuel cell 104 and the middle fuel cell 106 comprise at least an MEA having a cathode 108, 114, 120, an anode 110, 116, 122 and a membrane 112, 118, 124 therebetween, respectively. The membranes 112 and 124 have a lower water diffusion coefficient than the membrane 118 of the middle fuel cell 106. As a result, the water back diffusion from the cathode 108, 120 to the anode 110, 122 is reduced in the top and bottom fuel cells 102, 104 in comparison to the water transfer occurring in the middle fuel cell 106. Alternatively, the membrane of the MEAs can have a varying water solubility coefficient or a varying ion exchange water capacity from the two end fuel cells to the middle fuel cell. It should be understood that the membranes can have at least one of a varying water diffusion coefficient, a varying water solubility coefficient and a varying ion exchange water capacity across the fuel cell stack or any combination thereof.

In an embodiment, the end cells have membranes made out of material having lower water solubility and/or lower water diffusion coefficient and/or lower ion exchange water capacity, with all other cells in the stack having a standard membrane.

In an embodiment, at least one fuel cell located at the top of the fuel cell stack has a membrane made out of material having lower water solubility and/or lower water diffusion coefficient and/or lower ion exchange water capacity than that of the fuel cell located in the middle of the fuel cell stack.

In an embodiment, at least one fuel cell located at the bottom of the fuel cell stack has a membrane made out of material having lower water solubility and/or lower water diffusion coefficient and/or lower ion exchange water capacity than that of the fuel cell located in the middle of the fuel cell stack.

In an embodiment, at least one fuel cell located at the top of the fuel cell stack and at least one fuel cell located at the bottom of the fuel cell stack have a membrane made out of material having lower water solubility and/or lower water diffusion coefficient and/or lower ion exchange water capacity than that of the fuel cell located in the middle of the fuel cell stack.

Alternatively, the water solubility and/or water diffusion coefficient and/or lower ion exchange water capacity of the membranes can gradually or abruptly increase from at least one of the top end fuel cells to the middle fuel cell.

Alternatively, the water solubility and/or water diffusion coefficient and/or lower ion exchange water capacity of the membranes can gradually or abruptly increase from at least one of the bottom end fuel cells to the middle fuel cell.

It should also be noted that at least one membrane can also have a non-uniform capability of water transfer from the cathode electrode to the anode electrode according to the subject matter disclosed in PCT Patent Application entitled “Fuel cell stack water management” filed on Aug. 7, 2007, the contents of which are hereby incorporated by reference. The non-uniform capability of water transfer is achieved by at least one of a non-uniform thickness of the membrane, a non-uniform water solubility coefficient, a non-uniform water diffusion coefficient and a non-uniform ion exchange capability along the membrane.

It should be understood that any combination of the membranes having varying water transfer capacity throughout the stack may be provided.

Reducing the anode flooding in the end fuel cells can also be achieved by varying the hydrophilicity of the gas diffusion layers within the end fuel cells or by rendering these layers hydrophobic.

Depositing a film of hydrophobic or hydrophilic material on the gas diffusion layers is one of the methods that can be used to alter a gas diffusion layer's ability to repel or attract water.

It should be understood that any treatment done to the gas diffusion layer which varies its affinity to water can be employed. The treatment may be applied only to one of the two or more gas diffusion layers in the MEA, or to more than one, up to and including all of the gas diffusion layers in a fuel cell.

In an embodiment, the end cells have less hydrophilic gas diffusion layers than other fuel cells in the stack having standard gas diffusion layers.

In an embodiment, at least one fuel cell located at the top of the fuel cell stack has less hydrophilic gas diffusion layers than the gas diffusion layers of the fuel cell located at the center of the fuel cell stack.

In an embodiment, at least one fuel cell located at the bottom of the fuel cell stack has less hydrophilic gas diffusion layers than the gas diffusion layers of the fuel cell located at the center of the fuel cell stack.

In an embodiment, at least one fuel cell located at the top of the fuel cell stack and at least one fuel cell located at the bottom of the fuel cell stack have less hydrophilic gas diffusion layers than the gas diffusion layers of the fuel cell located at the center of the fuel cell stack.

In another embodiment, the fuel cells located substantially at the center of the fuel cell stack can be made of hydrophilic material and at least one fuel cell located at one end or another of the fuel cell stack is made of hydrophobic material.

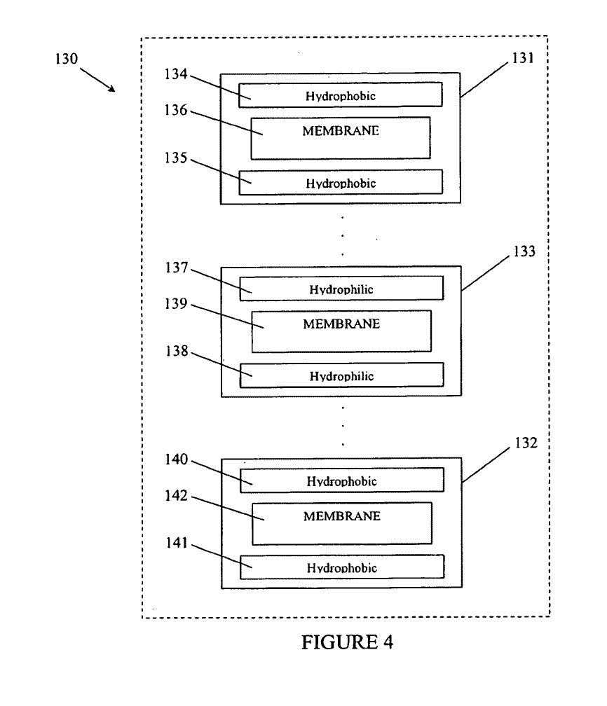

FIG. 4 illustrates an embodiment of the fuel cell stack 130 having a top fuel cell 131, a bottom fuel cell 132 and at least one fuel cell 133 between the top fuel cell 131 and the bottom fuel cell 132, each fuel cell comprising a cathode gas diffusion layer 134, 140, 137, an anode gas diffusion layer 135, 141, 138 and a membrane 136, 142, 139 therebetween, respectively. The cathode gas diffusion layers 134, 140 and the anode gas diffusion layers 135, 141 are made of an hydrophobic material. The cathode gas diffusion layer 137 and the anode gas diffusion layer 138 are made of an hydrophilic material. As a result, the anode flooding occurring the end fuel cells 131, 132 is reduced.

In another embodiment, the cathode gas diffusion layers of the end fuel cells are made of an hydrophobic material and the anode gas diffusion layers of the end fuel cells are less hydrophilic than the anode and cathode gas diffusion layers of the middle fuel cells.

It should be noted that any combination of cathode gas diffusion layers and anode gas diffusion layers a having varying hydrophobicity or hydrophilicity across the fuel cell stack may be provided.

It should be understood that any treatment known by a person skilled in the art to alter the hydrophobicity or the hydrophilicity of any material used to make gas diffusion layers can used.

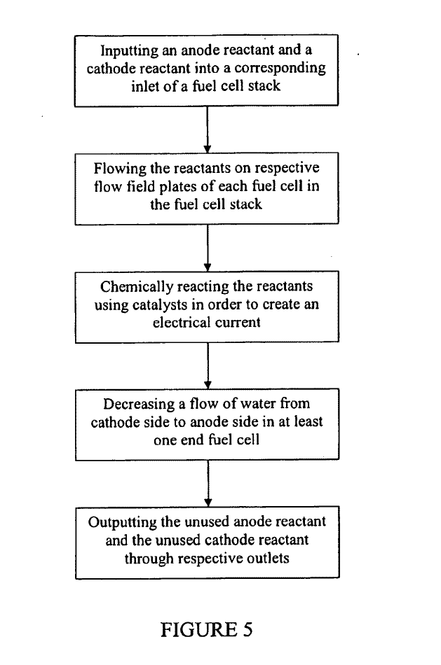

FIG. 5 illustrates an embodiment of the method used to operate a fuel cell stack. The anode and cathode reactants enter a fuel cell via an anode inlet and cathode inlet, respectively. The fuel cell comprises at least an anode flow field plate, a cathode flow field plate and an MEA in between. The MEA comprises, in one embodiment, an anode gas diffusion layer, a cathode gas diffusion layer, an anode catalyst, a cathode catalyst and a membrane in between. In the flow field plates, the corresponding reactant flows on a flow field. The reactants chemically react to give rise to an electrical and to the creation of water (i.e. the production water). The production water adds to the humidifying water present into the reactants. The flow of water from the cathode side to the anode side is reduced in at least one end fuel cells. Finally, the unused anode reactant and cathode reactant exits the fuel cell by an anode outlet and a cathode outlet. The reduction of the water transfer in the end fuel cell can be achieved by at least one of providing a thicker membrane, providing a membrane made of a different material and changing the affinity to water of at least one gas diffusion layer. The material of the membrane of the end fuel cell can have a lower water solubility and/or water diffusion coefficient and/or ion exchange capacity than the material of the membrane of the middle fuel cell. The gas diffusion layer in the end fuel cell can be treated to be less hydrophilic than the gas diffusion layer in the middle fuel cell. Alternatively, the gas diffusion layers of the end fuel cell can be treated to be become hydrophobic.

In an embodiment of the method, the flow of water from the cathode side to the anode side is decreased in both end fuel cells.

In an embodiment, the flow of water from the cathode side to the anode side is decreased in at least one fuel cell located at the top of the fuel cell stack.

In an embodiment, the flow of water from the cathode side to the anode side is decreased in at least one fuel cell located at the bottom of the fuel cell stack.

In an embodiment, the flow of water from the cathode side to the anode side is decreased in at least one fuel cell located at the top of the fuel cell stack and at least one fuel cell located at the bottom of the fuel cell stack.

Alternatively, the flow of water from the cathode side to the anode side decreases from the middle fuel cell to at least one of the top end fuel cells.

Alternatively, the flow of water from the cathode side to the anode side decreases from the middle fuel cell to at least one of the bottom end fuel cells.

Yet another embodiment comprises using MEAs having different electrode catalyst layers. The low temperature at end fuel cells cause an accelerated degradation of the performance of the electrode catalyst layers located in these fuel cells. As a result the lifetime of these electrode catalyst layers is shortened.

One embodiment uses electrode catalyst layers having different loadings (such as Pt or Pt-alloy). MEAs having electrode catalyst layers provided with a high catalyst loading will have a degradation that will be delayed in comparison to MEAs having electrode catalyst layers having a regular catalyst loading.

It should be understood that any technique known by a person skilled in the art which enables to vary the catalyst loading can be used as an electrode coating.

In one embodiment, the MEAs of the two end fuel cells have higher cathode or anode catalyst loadings than the MEA of the middle fuel cell.

In an embodiment of the present device, at least one of the MEAs of the fuel cells located at the top of the fuel cell stack has a higher cathode or anode catalyst loading than the MEA of a fuel cell located in the middle of the fuel cell stack.

In an embodiment of the present device, at least one of the MEAs of the fuel cells located at the bottom of the fuel cell stack has a higher cathode or anode catalyst loading than the MEA of a fuel cell located in the middle of the fuel cell stack.

In an embodiment of the present device, at least one of the MEAs of the fuel cells located at the top of the fuel cell stack and one of the MEAs of the fuel cells located at the bottom of the fuel cell stack have a higher cathode or anode catalyst loading than the MEA of a fuel cell located in the middle of the fuel cell stack.

Alternatively, the catalyst loading of the MEA's anode or cathode can gradually or abruptly decrease from at least one of the top end fuel cells to the middle fuel cell.

Alternatively, the catalyst loading of the MEA's anode or cathode can gradually or abruptly decrease from at least one of the bottom end fuel cells to the middle fuel cell.

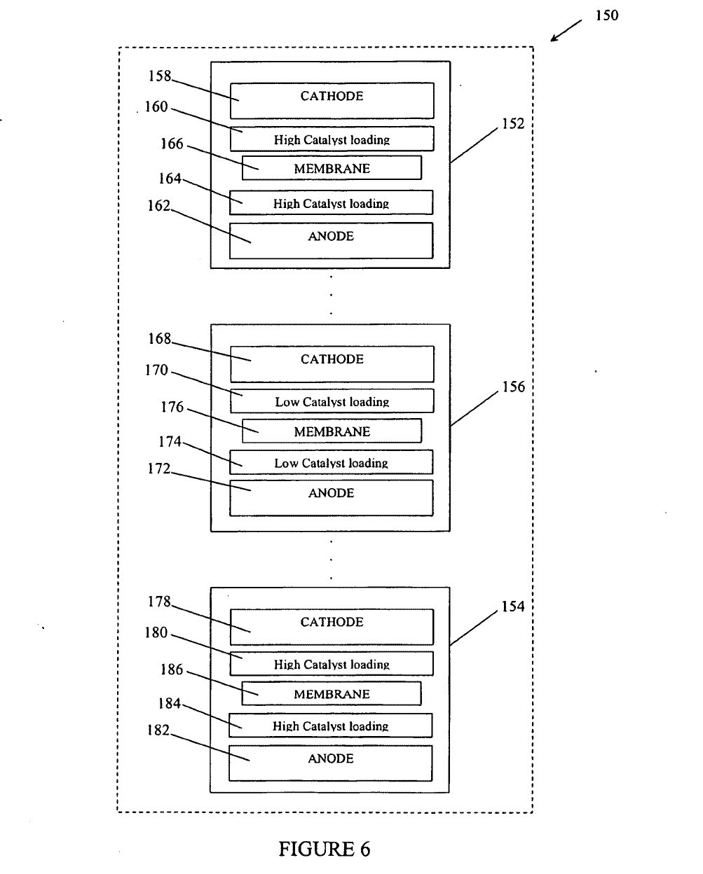

Yet another embodiment is to employ MEAs that have different anode and cathode catalyst loadings, such as, for example, the total catalyst loadings (the sum of the anode catalyst loading and the cathode catalyst loading) is higher at the end fuel cells than at the middle fuel cell. This is illustrated in FIG. 6. A fuel cell stack 150 comprises a top fuel cell 152, a bottom fuel cell 154 and at least one fuel cell 156 between the top fuel cell 152 and the bottom fuel cell 154. Each of the top fuel cell 152, the bottom fuel cell 154 and the fuel cell 156 comprise an MEA having a cathode 158, 178, 168, a cathode catalyst layer 160, 180, 170, a membrane 166, 186, 176, an anode catalyst layer 164, 184, 174, and an anode 162, 182, 172, respectively. The cathode catalyst layer 160 and the anode catalyst layer 164 of the top fuel cell 152 as well as the cathode catalyst layer 180 and the anode catalyst layer 184 of the bottom fuel cell 154 have higher loadings than the loadings of the cathode catalyst layer 170 and the anode catalyst layer 174 of the fuel cell 156. The high loading compensates for the higher fuel cell performance degradation rates of the electrode catalyst layers 160, 164, 180, 184 of the top 152 and bottom 154 fuel cells. As a result, the fuel cells 152, 154 and 156 have the same lifetime.

Another way to manage the performance of a fuel cell is to adjust the current density at which it is operated.

For example, low temperature at end fuel cell causes degradation of the fuel cell stack performance through anode or cathode flooding occurring in this end fuel cell. Thus increasing the temperature in the end fuel cell enables to improve fuel cell stack thermal distribution and hence to stop the anode flooding. The increase of temperature in the end fuel cell can be achieved by operating this end fuel cell at a higher current density, which results in a lower fuel cell voltage. Hence, more energy is dissipated as heat and the temperature of the fuel cell increases.

The current density of a fuel cell can be adjusted by varying the surface of the active area of the MEA located in the fuel cell. For example, providing an end fuel cell with an MEA of smaller active area in comparison to the active area of MEAs in other fuel cells in the fuel cell stack will increase its current density as a fuel cell stacks operates with a constant current. The active area of an MEA is defined as the part of the membrane's surface covered by the anode/cathode catalyst layers and the anode/cathode flow fields.

The surface of the active area of the MEA can be adjusted be varying the surface of at least one electrode catalyst layer and/or at least one flow field of the flow field plates and/or the membrane. Alternatively, the surface of the active area can be varied by placing at least one of the catalyst layers, the flow fields and the membrane out of alignment with the other elements used to create the active area. A combination of different surface and out of alignment is also possible. It should be understood that any technique known by a person skilled in the art to vary the surface of the active area of an MEA can be used and falls within the scope of the present device.

In one embodiment of the present device, at least one of the fuel cells located at the top of a fuel cell stack is provided with an MEA having a smaller active area than the MEA of a fuel cell stack located at the center of the fuel cell stack.

In one embodiment of the present device, at least one of the fuel cells located at the bottom of a fuel cell stack is provided with an MEA having a smaller active area than the MEA of a fuel cell stack located at the center of the fuel cell stack.

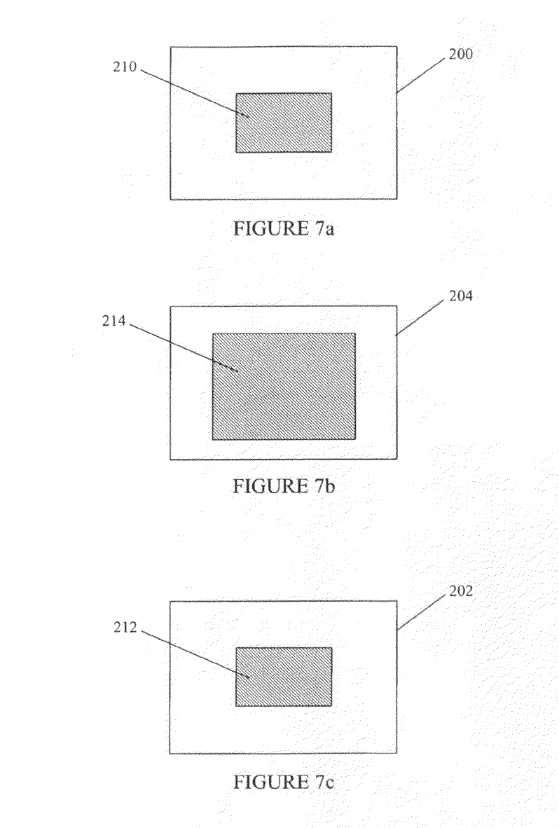

In one embodiment, only the fuel cell located at the top of the fuel cell stack and the fuel cell located at the bottom of the fuel cell stack have an MEA having a smaller active area than an MEA of the middle fuel cell. This is illustrated in FIGS. 7a, 7b and 7c. The active area 210 of the top fuel cell 200 and the active area 212 of the bottom fuel cell 202 are smaller than the active area 214 of the middle fuel cell 204. This results in a greater generation of heat in the top 200 and bottom 202 fuel cells than in the middle fuel cell 204. This additional heat generation compensates for the thermal loss suffered by the end fuel cells 200 and 202 and improve the temperature distribution uniformity across the fuel cell stack.

In another embodiment of the present device, at least one of the fuel cells located at the top of a fuel cell stack and at least one of the fuel cells located at the bottom of a fuel cell stack are provided with an MEA having a smaller active area than the MEA of a fuel cell stack located at the center of the fuel cell stack.

It may be only the end cells that have the smaller MEA active area, and all other cells in the stack have standard areas. Alternatively, the MEA reactive areas may decrease gradually or abruptly from the top end cell to the middle cell, and increase gradually or abruptly from the middle cell to the bottom end cell. This also applies when it is only one of the catalyst reactive area, i.e. anode catalyst reactive area or cathode catalyst reactive area, that is of a varying catalyst reactive area.

It should be understood that the description above is an example only. In some circumstances (such as under higher current density operation conditions), the end cells MEA active area may be larger than the middle cells to improve the end cell lifetime. Alternatively, the top (or bottom) cell active area may be smaller while the bottom (top) cell active area may be larger than the middle cell active area.

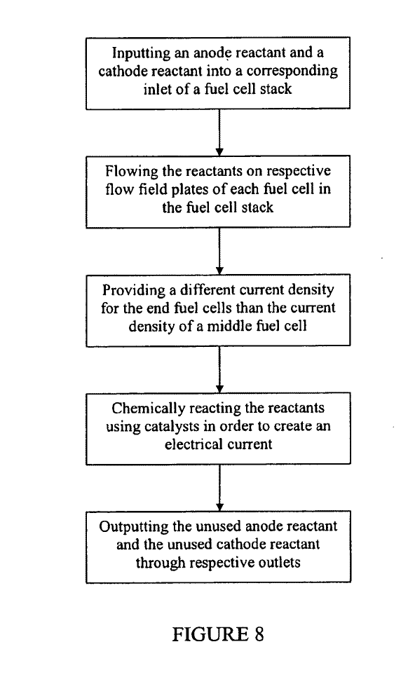

FIG. 8 illustrates an embodiment of the method used to operate a fuel cell stack. The anode and cathode reactants enter a fuel cell via an anode inlet and cathode inlet, respectively. The fuel cell comprises at least an anode flow field plate, a cathode flow field plate and an MEA in between. The MEA comprises, in one embodiment, an anode gas diffusion layer, a cathode gas diffusion layer, an anode catalyst, a cathode catalyst and a membrane in between. In the flow field plates, the corresponding reactant flows on a flow field. The end fuel cells are provided with a different current density than the current density of the middle cell. A different density is achieved by providing the MEA of the end fuel cells with a different surface of the active area than the surface of the active area of the middle fuel cell. The reactants chemically react to give rise to an electrical. Furthermore, the unused anode reactant and cathode reactant exits the fuel cell by an anode outlet and a cathode outlet.

One method to vary the current density is to vary the surface of the active area of the MEA in the fuel cell. It should be understood that any method permitting the variation of the current density of an MEA in a fuel cell can be used and falls within the scope of the present method.

In one embodiment of the method, the top and bottom fuel cells are provided with a higher current density than the current density of the middle fuel cell.

In an embodiment of the method, at least one of the fuel cells located at the top of a fuel cell stack is provided with a higher current density than the current density of the middle fuel cell.

In one embodiment of the present method, at least one of the fuel cells located at the bottom of a fuel cell stack is provided with a higher current density than the current density of the middle fuel cell.

In another embodiment of the method, at least one of the fuel cells located at the top of a fuel cell stack and at least one of the fuel cells located at the bottom of a fuel cell stack are provided with a higher current density than the current density of the middle fuel cell.

It may be only the end fuel cells that are provided with the higher current density, and all other cells in the fuel cell stack are provided with standard current density. Alternatively, the current density of fuel cells may decrease gradually or abruptly from the top end cell to the middle cell, and increase gradually or abruptly from the middle cell to the bottom end cell.

It should be understood that the description above is an example only. In some circumstances (such as under higher current density operation conditions), the fuel end cells are provided with a smaller current than the middle cells to improve the end fuel cell lifetime. Alternatively, the top (or bottom) fuel cell is provided with smaller current density while the bottom (top) cell is provided with a larger current density than the middle cell active area.

It should be understood that a combination of any of the above techniques is possible without deviating from the scope of the present invention. The embodiments of the invention described above are intended to be exemplary only. The scope of the invention is therefore intended to be limited solely by the scope of the appended claims.

1. A fuel cell stack comprising:
a plurality of fuel cells each having at least an anode plate, a cathode plate and a membrane electrode assembly (MEA) therebetween, at least one of said plurality of fuel cells having at least one of a membrane and a diffusion layer in said MEA with a first water transportation capability and another one of said plurality of fuel cells having at least one of a membrane and a diffusion layer in said MEA with a second water transportation capability, said first water transportation capability and said second water transportation capability being different.

2. A fuel cell stack as claimed in claim 1, wherein said at least one of said plurality of fuel cells is an end cell of said fuel cell stack.

3. A fuel cell stack as claimed in claim 2, wherein said another one of said plurality of fuel cells is a middle cell of said fuel cell stack.

4. A fuel cell stack as claimed in claim 1, wherein said first water transportation capability is less than said second water transportation capability.

5. A fuel cell stack as claimed in claim 4, wherein fuel cells positioned between said end cell and said middle cell have water transportation capabilities that gradually increase towards said middle cell.

6. A fuel cell stack as claimed in claim 1, wherein said first water transportation capability comprises a first membrane thickness and said second water transportation capability comprises a second membrane thickness.

7. A fuel cell stack as claimed in claim 1, wherein said first water transportation capability comprises a first membrane material and said second water transportation capability comprises a second membrane material.

8. A fuel cell stack as claimed in claim 7, wherein said first membrane material has a lower water solubility than said second membrane material.

9. A fuel cell stack as claimed in claim 7, wherein said first membrane material has a lower water diffusion coefficient than said second membrane material.

10. A fuel cell stack as claimed in claim 7, wherein said first membrane material has a lower ion exchange capacity than said second membrane material.

11. A fuel cell stack as claimed in claim 1, wherein said first water transportation capability comprises a first gas diffusion layer hydrophilicity and said second water transportation capability comprises a second gas diffusion layer hydrophilicity.

12-19. (canceled)

20. A fuel cell stack comprising:
a plurality of fuel cells each having at least an anode plate, a cathode plate and a membrane electrode assembly (MEA) therebetween, at least one of said plurality of fuel cells having a catalyst in said MEA comprising a first catalyst loading and another one of said plurality of fuel cells having a catalyst in said MEA comprising a second catalyst loading, said first catalyst loading and said second catalyst loading being different.

21. A fuel cell stack comprising:
a plurality of fuel cells each having at least a pair of flow field plates and a membrane electrode assembly (MEA) therebetween;
at least one of said plurality of fuel cells having a first catalyst covering a first membrane and aligned with a first flow field on at least one of said flow field plates to create a first active area; and
another one of said plurality of fuel cells having a second catalyst covering a second membrane and aligned with a second flow field on at least one of said flow field plates to create a second active area, said first active area and said second active area being of different dimensions.

22. A fuel cell stack as claimed in claim 21, wherein said at least one of said plurality of fuel cells is an end cell of said stack.

23. A fuel cell stack as claimed in claim 22, wherein said another one of said plurality of fuel cells is a middle cell of said stack.

24. A fuel cell stack as claimed in claim 20, wherein said first catalyst loading is higher than said second catalyst loading.

25. A fuel cell stack as claimed in claim 23, wherein fuel cells positioned between said end cell and said middle cell have catalyst loadings that gradually decrease towards said middle cell.

26. A fuel cell stack as claimed in claim 21, wherein said first active area and said second active area are of different dimensions due to a difference in dimensions of said first membrane and said second membrane.

27. A fuel cell stack as claimed in claim 21, wherein said first active area and said second active area are of different dimensions due to a difference in surface area covered by said first catalyst and said second catalyst.

28. A fuel cell stack as claimed in claim 21, wherein said first active area and said second active area are of different dimensions due a difference in dimensions of said first flow field and said second flow field.

29. A fuel cell stack as claimed in claim 26, wherein fuel cells positioned between an end cell and a middle cell have active areas that gradually decrease in dimension towards said middle cell.

30. A fuel cell stack as claimed in claim 20, wherein said first catalyst loading and said second catalyst loading are anode catalyst loadings.

31. A fuel cell stack as claimed in claim 20, wherein said first catalyst loading and said second catalyst loading are cathode catalyst loadings.

32-37. (canceled)
